(19) United States
(12) Patent Application Publication
(10) Pub. No.: US 2020/0183982 A1
(43) Pub. Date: Jun. 11, 2020

(54) COMPUTER-READABLE RECORDING MEDIUM, ANALYSIS METHOD, AND ANALYZING APPARATUS

(71) Applicant: FUJITSU LIMITED, Kawasaki-shi (JP)

(72) Inventors: Shohei Yamane, Kawasaki (JP); Hiroaki Yamada, Kawasaki (JP); Kotaro Ohori, Chuo (JP); Hirokazu Anai, Hachioji (JP); Shingo Takahashi, Shinjuku (JO)

(73) Assignee: FUJITSU LIMITED, Kawasaki-shi (JP)

(21) Appl. No.: 16/702,709

(22) Filed: Dec. 4, 2019

(30) Foreign Application Priority Data
Dec. 6, 2018 (JP) 2018-229398

(51) Int. Cl. G06F 16/906; G06F 16/901; G06Q 50/30; G06Q 50/28

(52) U.S. Cl. CPC G06F 16/906; G06Q 50/28; G06Q 50/30; G06F 16/901

(57) ABSTRACT

A non-transitory computer-readable recording medium has stored therein a program that causes a computer to execute a process including, classifying a plurality of data items included in outputted data output by carrying out a simulation using a plurality of agents into a plurality of groups based on difference between model elements of data output sources of the respective data items in the agents, converting the data items included in a group having a plurality of data items out of the groups into a smaller number of data items than a number of data items included in the group based on a predetermined rule, and identifying a combination of the data items having an appearance tendency equal to or higher than a predetermined value in the outputted data resulting from the converting.

### CROSS-REFERENCE TO RELATED APPLICATION(S)

This application is based upon and claims the benefit of priority of the prior Japanese Patent Application No. 2018-229398, filed on Dec. 6, 2018, the entire contents of which are incorporated herein by reference.

### FIELD

The embodiment discussed herein is related to a computer-readable recording medium, an analysis method, and an analyzing apparatus.

### BACKGROUND

People flow simulations are conventionally used to consider capital investment, such as distribution of personnel and installation of counters, for eliminating congestion in airports and other places (e.g., Japanese Laid-open Patent Publication No. 2017-224201). In the people flow simulation, the conventional technique disposes equipment according to a plan of capital investment and a plurality of pedestrian agents (hereinafter, also referred to as agents) that imitate pedestrians in a virtual space to be evaluated. The conventional technique then simulates behavior of the pedestrian agents based on information obtained by acquiring (recognizing) the equipment disposed in the virtual space. By checking behavior logs of the pedestrian agents output by the simulation, the conventional technique evaluates the plan (measure) of capital investment.

The conventional technique described above, however, has an enormous number of types (number of items) of data to be considered in the behavior logs of the pedestrian agents output as the simulation result. This makes it difficult to analyze the data items obtained by the simulation and consider a measure to eliminate congestion. Even for experts, for example, take a lot of time to consider the measure.

### SUMMARY

According to an aspect of an embodiment, a non-transitory computer-readable recording medium has stored therein a program that causes a computer to execute a process including, classifying a plurality of data items included in outputted data output by carrying out a simulation using a plurality of agents into a plurality of groups based on difference between model elements of data output sources of the respective data items in the agents, converting the data items included in a group having a plurality of data items out of the groups into a smaller number of data items than a number of data items included in the group based on a predetermined rule, and identifying a combination of the data items having an appearance tendency equal to or higher than a predetermined value in the outputted data resulting from the converting.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an analysis of simulation output data;

FIG. 2 is a diagram for explaining agent models;

FIG. 3 is a diagram for explaining output of the models;

FIG. 4 is a block diagram of an exemplary functional configuration of an information processing apparatus according to an embodiment;

FIG. 5 is a diagram for explaining an example of the simulation output data;

FIG. 6 is a diagram for explaining an example of a classification result;

FIG. 7 is a diagram for explaining an example of a conversion result;

FIG. 8 is a flowchart of an exemplary operation of the information processing apparatus according to the embodiment;

FIG. 9 is a diagram for explaining identification of combinations;

FIG. 10 is a diagram for explaining consideration of a measure from the identified combination;

FIG. 11 is a diagram for explaining an example of effects; and

FIG. 12 is a block diagram of an example of a hardware configuration of the information processing apparatus according to the embodiment.

### DESCRIPTION OF EMBODIMENTS

Preferred embodiments of the present invention will be explained with reference to accompanying drawings. Components having like functions according to the embodiments are denoted by like reference numerals, and overlapping explanation thereof is omitted. The computer-readable recording medium, the analysis method, and the analyzing apparatus described in the embodiments below are given by way of example only and are not intended to limit the embodiments. The embodiments below may be appropriately combined without being inconsistent.

Analysis of Simulation Results

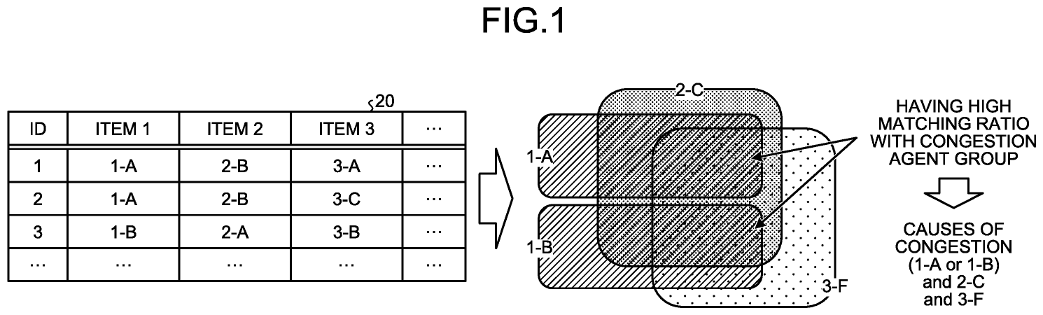

FIG. 1 is a diagram for explaining an analysis of simulation output data. As illustrated in FIG. 1, a people flow simulation in a facility (an airport in the present embodiment) is carried out using a plurality of agents, thereby obtaining simulation output data 20. The simulation output data 20 includes logs corresponding to behavior contents of the respective agents identified by IDs and the like. The simulation output data 20 stores therein values (1-A, 1-B, . . . ) indicating the states of the agents reproduced on the simulation for each of data items (item 1, item 2, item 3, . . . ) indicating the behavior contents. While the present embodiment describes the simulation using the agents that imitate pedestrians, the agents do not necessarily imitate pedestrians. The agents may imitate animals other than humans, vehicles, and other objects based on the contents of the simulation to be carried out.

In consideration of a measure to deal with congestion or the like using the simulation output data 20, data on a congestion agent group having a data item of waiting time of a predetermined value (e.g., 30 minutes) or larger is determined to be analyzed. Subsequently, data items having a high matching ratio with the congestion agent group to be analyzed and combinations of their values are found out, thereby presuming the causes of congestion. As the number of types of data (number of items or values of the items) to be considered becomes larger, the consideration becomes more difficult. In execution of the simulation, as the simulation becomes more precise, definitions and output data on the agents become more exact and increase in number. Furthermore, in presumption of the causes of congestion and consideration of the measure, the values of the logs in the simulation may possibly not be appropriate (may possibly be excessively precise).

To address this, the present embodiment focuses on models (agent models) for simulating the behavior relating to the agents and organizes the data items output by each of the models based on the difference between model elements, thereby reducing the number of types of data to be considered. As described above, the present embodiment reduces the number of types of data, thereby supporting and facilitating a user's considering a measure.

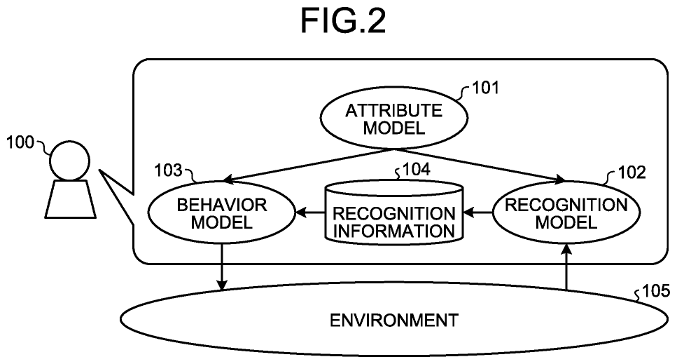

FIG. 2 is a diagram for explaining the agent models. As illustrated in FIG. 2, agents 100 each have an attribute model 101, a recognition model 102, and a behavior model 103 as elements of the simulation. The agent 100 is a subject that acts autonomously in an environment 105 represented as a space in which the agent 100 acts on the simulation. The agent 100 serving as the action subject may be an individual or a group of a plurality of persons, such as families.

The attribute model 101 is unique characteristics of the agent 100 unchangeable in the simulation. The attribute model 101 includes data items, such as object including a boarding flight, age, and sex, defined in advance for the agent 100. The attribute model 101 affects parameters of the recognition model 102 and the behavior model 103.

The recognition model 102 relates to acquisition of information (recognition) from the environment 105 in the agent 100. The recognition model 102 is affected by the attribute model 101, such as object, age, and sex, and acquires recognition information 104 from the environment 105.

The behavior model 103 relates to an effect (behavior) to the environment 105 in the agent 100. The behavior model 103 performs an action determined based on the attribute model 101, such as object, age, and sex, and the recognition information 104 received from the environment 105, thereby having an effect corresponding to the behavior on the environment 105.

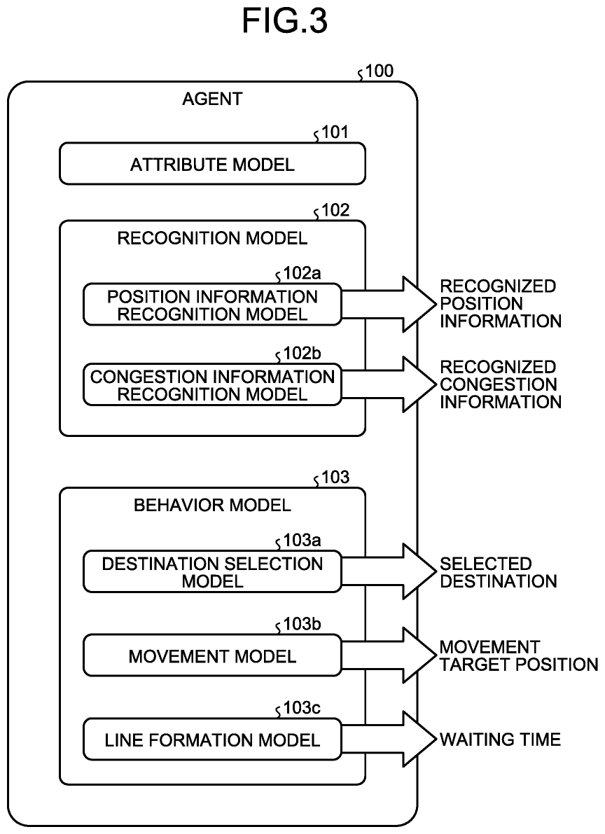

FIG. 3 is a diagram for explaining output of the models. As illustrated in FIG. 3, the attribute model 101, the recognition model 102, and the behavior model 103 are each collectively represented in the same form, for example. By classifying and organizing data items based on the difference between the model elements (models or sub-models), the present embodiment can reduce the number of types of data and their values.

A position information recognition model 102a serving as a sub-model of the recognition model 102, for example, is represented in the same form as recognized position information. Consequently, the present embodiment can organize the data items output by the position information recognition model 102a as the recognized position information. Similarly, the present embodiment can organize the data items output by a congestion information recognition model 102b as recognized congestion information.

The data items output by the behavior model 103 are organized in the same manner as described above. The present embodiment can organize the data items output by a destination selection model 103a serving as a sub-model of the behavior model 103 as selected destination, for example. Similarly, the present embodiment can organize the data items output by a movement model 103b as movement target position and organize the data items output by a line formation model 103c as waiting time.

As described above, the present embodiment organizes the data items based on the difference between the models. Consequently, the present embodiment can facilitate finding out the data items having a high matching ratio with the congestion agent group and combinations of their values in the relation of attribute-recognition-behavior.

Functional Configuration of the Analyzing Apparatus

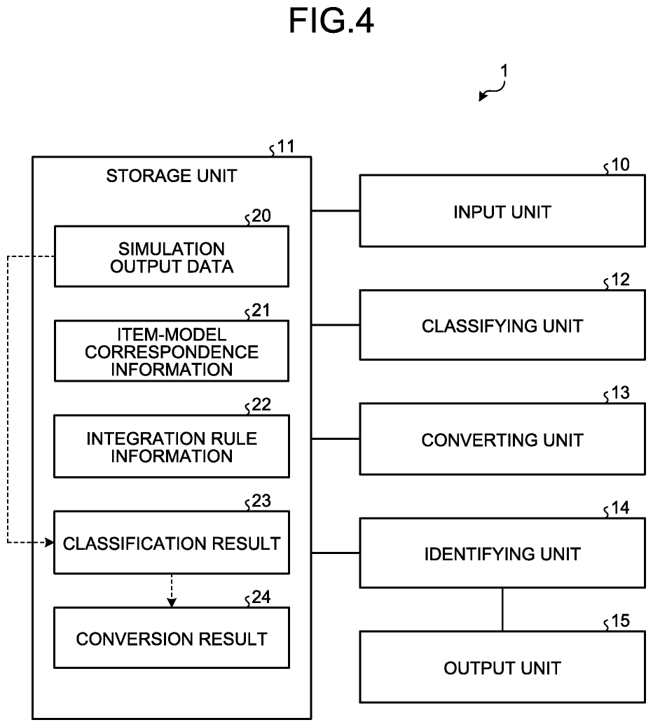

FIG. 4 is a block diagram of an exemplary functional configuration of an information processing apparatus according to the embodiment. An analyzing apparatus 1 illustrated in FIG. 4 is an example of the analyzing apparatus and is a computer, such as a server computer. The analyzing apparatus 1 may be provided as one computer or a computer system including a plurality of computers. In other words, the configuration of the analyzing apparatus 1 described below may be provided by distributing the processing in an information processing system including a plurality of computers. The analyzing apparatus 1 according to the present embodiment is one computer, for example.

As illustrated in FIG. 4, the analyzing apparatus 1 includes an input unit 10, a storage unit 11, a classifying unit 12, a converting unit 13, an identifying unit 14, and an output unit 15.

The input unit 10 is a processing unit that receives input of various kinds of data and stores the received data in the storage unit 11. The input unit 10, for example, receives input of the simulation output data obtained as the results of a people flow simulation using a plurality of agents 100 and stores the received simulation output data 20 in the storage unit 11. The input unit 10 also receives input of setting information, such as item-model correspondence information 21 and integration rule information 22, and stores the received setting information, such as the item-model correspondence information 21 and the integration rule information 22, in the storage unit 11.

The storage unit 11 is a storage device, such as a hard disk device, and stores therein various kinds of information, such as the simulation output data 20, the item-model correspondence information 21, the integration rule information 22, a classification result 23, and a conversion result 24.

The simulation output data 20 includes logs corresponding to the attributes and the behavior contents of the agents 100 in a manner associated with the IDs indicating the respective agents 100 each corresponding to an individual or a group.

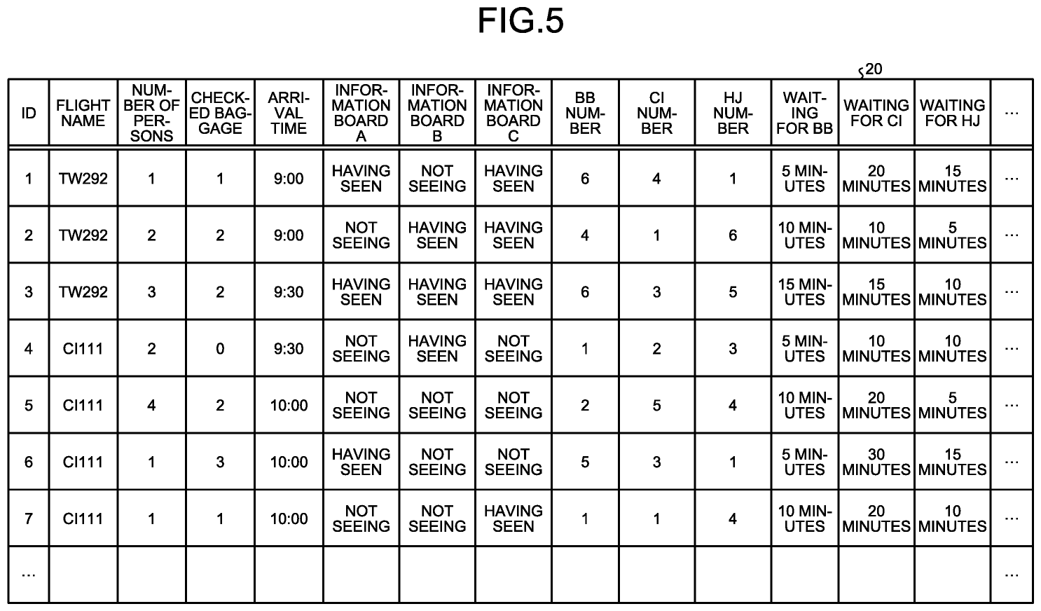

FIG. 5 is a diagram for explaining an example of the simulation output data 20. As illustrated in FIG. 5, the simulation output data 20 stores therein the values indicating the state of each of the agents 100 (IDs) reproduced on the simulation as the data items (flight name, number of persons, . . . ) corresponding to the attributes and the behavior contents.

The simulation output data 20 may be obtained by collecting log data on the agents 100 having behavior in the simulation satisfying a predetermined condition. The simulation output data 20 may be obtained by collecting log data corresponding the congestion agent group having waiting time, such as waiting for BB, waiting for CI, and waiting for HJ, of a predetermined value (30 minutes) or longer.

The item-model correspondence information 21 indicates the models serving as the output sources of the data items, that is, the correspondence between the data items in the simulation output data 20 and the attribute model 101, the recognition model 102, the behavior model 103, and the sub-models of the agent 100. The item-model correspondence information 21, for example, indicates {flight name, number of persons, checked baggage, and arrival time} as the data items on the attribute model 101. The item-model correspondence information 21 indicates {information board A, information board B, and information board C} as the data items on an information board recognition model serving as a sub-model of the recognition model 102. The item-model correspondence information 21 indicates {BB number, CI number, and HJ number} as the data items on the destination selection model 103a serving as a sub-model of the behavior model 103. Similarly, the item-model correspondence information 21 indicates {waiting for BB, waiting for CI, and waiting for HJ} as the data items on the line formation model 103c serving as a sub-model of the behavior model 103.

By referring to the item-model correspondence information 21, the present embodiment can classify the data items included in the simulation output data 20 into groups corresponding to the attribute model 101, the recognition model 102, the behavior model 103, and the sub-models of the agent 100. The item-model correspondence information 21 is set by the user and stored in the storage unit 11 via the input unit 10.

The integration rule information 22 indicates rules (regulations) for organizing the data for the groups of the data items classified based on the models of the agent 100. Specifically, the integration rule information 22 describes the rules for organizing the data for each of the groups of the data items classified into the attribute model 101, the recognition model 102, the behavior model 103, and the sub-models of the agent 100.

The classification result 23 is a result of processing performed on the simulation output data 20 by the classifying unit 12 based on the item-model correspondence information 21. The conversion result 24 is a result of processing performed on the simulation output data 20 by the converting unit 13 based on the classification result 23 and the integration rule information 22.

The classifying unit 12 is a processing unit that classifies the data items included in the simulation output data 20 based on the item-model correspondence information 21. Specifically, the classifying unit 12 refers to the item-model correspondence information 21 and identifies the models serving as the output sources (the attribute model 101, the recognition model 102, the behavior model 103, and the sub-models of the agent 100) of the data items included in the simulation output data 20. Subsequently, the simulation output data 20 classifies the data items into a plurality of groups based on the difference between the identified models and stores the processing result in the storage unit 11 as the classification result 23.

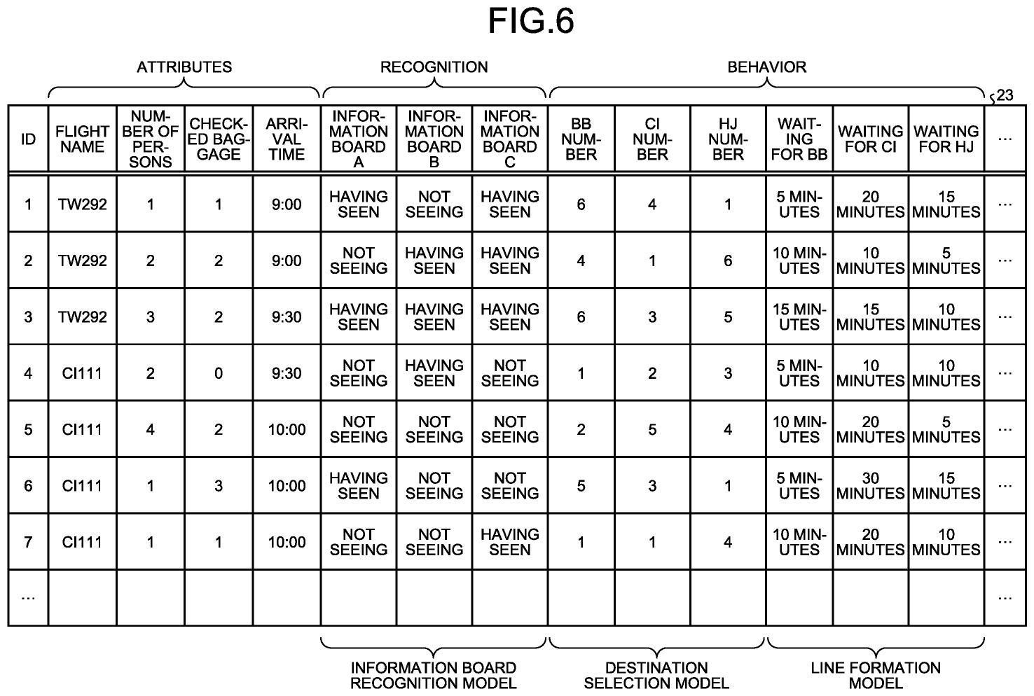

FIG. 6 is a diagram for explaining an example of the classification result 23. As illustrated in FIG. 6, in the classification result 23, the data items of flight name, number of persons, checked baggage, and arrival time in the simulation output data 20 are classified as a group of the “attributes” of the attribute model 101, for example. The data items of information board A, information board B, and information board C in the simulation output data 20 are classified as a group of the “information board recognition model” of the recognition model 102. The data items of BB number, CI number, and HJ number in the simulation output data 20 are classified as a group of the “destination selection model” of the behavior model 103. The data items of waiting for BB, waiting for CI, and waiting for HJ in the simulation output data 20 are classified as a group of the “line formation model” of the behavior model 103.

The converting unit 13 is a processing unit that organizes the data for each of the groups of the data items classified based on the models of the agent 100 in the simulation output data 20 and stores the processing result in the storage unit 11 as the conversion result 24. Specifically, the converting unit 13 organizes the data by dividing the groups resulting from classification by the classifying unit 12 in the classification result 23 into clusters by clustering according to the rules of the integration rule information 22. Subsequently, the converting unit 13 stores the conversion result 24 obtained by converting the simulation output data 20 into values assigned to the groups (e.g., values corresponding to the clusters divided by the clustering) in the storage unit 11.

Let us assume a case where the integration rule information 22 has a rule for clustering the data items relating to the information board recognition model such that they are clustered as three-dimensional binary data (information board A, information board B, and information board C: {having seen, not seeing, not seeing}={1,0,0}), for example. In this case, the generated clusters include: {0,0,0}, {0,0,1}, {0,1,0}, and {0,1,1} indicating clusters not seeing the information board A, {1,0,0} and {1,0,1} indicating clusters having seen the information board A but not seeing the information board B, and {1,1,0} and {1,1,1} indicating clusters having seen the information boards A and B.

Let us assume a case where the integration rule information 22 has a rule for clustering the data items relating to the destination selection model 103a such that they are clustered as string data of three characters corresponding to BB number, CI number, and HJ number. The data items are clustered as string data of three characters like BB number, CI number, and HJ number: {No. 2, No. 4, No. 3}=“243”, for example. In this case, the generated clusters include: “11*” and “12*” indicating clusters using BB No. 1, CI No. 1 or 2, and HJ with an optional number, and “2**” indicating a cluster using BB No. 2 and CI and HJ with optional numbers.

Let us assume a case where the integration rule information 22 has a rule for clustering the data items relating to the line formation model 103c such that they are clustered as three-dimensional real values corresponding to waiting time for BB, CI, and HJ. The data items are clustered as three-dimensional real values like waiting for BB, waiting for CI, and waiting for HJ: {10 minutes, 15 minutes, 5 minutes}={10,15,5}, for example. In this case, the generated clusters include: {less than 5, less than 5, less than 10} indicating a cluster having a short waiting time as a whole, {less than 5, 5 or more and less than 10, 15 or more} indicating a cluster having a long waiting time for HJ, and {10 or more and less than 15, or more and less than 15, less than 10} indicating a cluster having a little waiting time for BB and CI.

As described above, the converting unit 13 converts the data items included in the groups having a plurality of data items out of a plurality of groups resulting from classification by the classifying unit 12 in the classification result 23 into a smaller number of data items than the number of data items included in the groups based on the integration rule information 22.

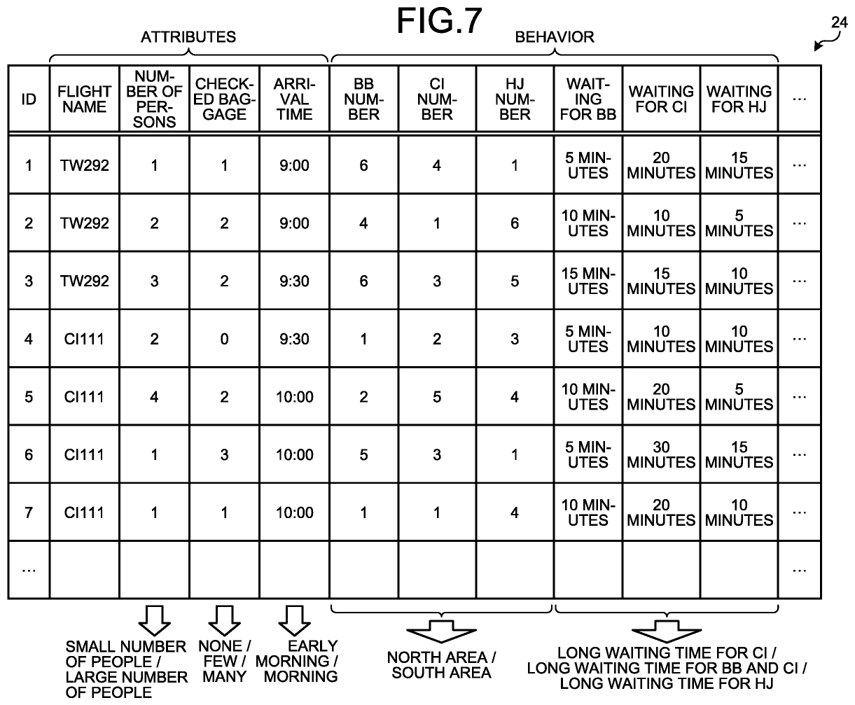

FIG. 7 is a diagram for explaining an example of the conversion result 24. As illustrated in FIG. 7, in the conversion result 24, the values of the data items relating to the attribute model 101 are divided into clusters based on the number of persons, the number of pieces of checked baggage, and the time period of arrival time by clustering, for example. The data items relating to the behavior model 103 and their values are divided into clusters organized according to the rules corresponding to the movement model 103b.

The identifying unit 14 is a processing unit that identifies a combination of data items having an appearance tendency equal to or higher than a predetermined value in the simulation output data 20 resulting from integration of data based on the conversion result 24 resulting from conversion by the converting unit 13. Specifically, the identifying unit 14 identifies a combination of data items that appears characteristically (having a high appearance tendency) out of the data items and their values included in the conversion result 24 using a known machine learning technique, for example.

The identifying unit 14 may identify the combination of data items having an appearance tendency equal to or higher than the predetermined value by combining the data items relating to the behavior model 103 of the agent 100 with other items based on the item-model correspondence information 21. As a result, the identifying unit 14 can identify the combination including the data item relating to the behavior of the agent 100 and including at least one of the data item relating to the behavior and the data item relating to the recognition.

The output unit 15 is a processing unit that outputs the combination relating to the data items identified by the identifying unit 14 on a display or a file, for example. As a result, the analyzing apparatus 1 outputs the combination identified by the identifying unit 14 to the display or the file, for example. The output unit 15, for example, outputs the combination including the data item relating to the effect of the agent 100 identified by the identifying unit 14 and including at least one of the data item relating to the effect and the data item relating to the acquisition of information.

Procedures of the Processing

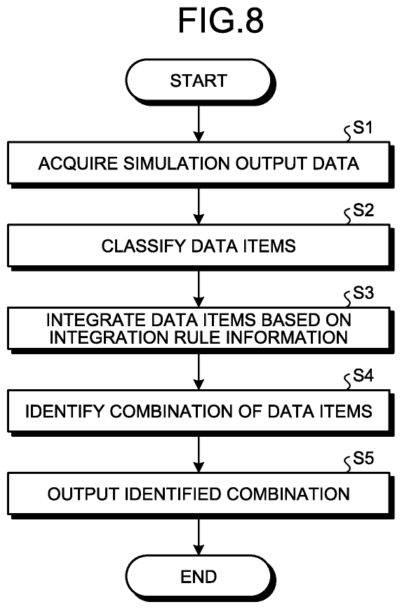

FIG. 8 is a flowchart of an exemplary operation of the analyzing apparatus 1 according to the embodiment. As illustrated in FIG. 8, when the processing starts, the input unit 10 acquires the simulation output data 20 obtained as the results of a people flow simulation (S1) and stores the acquired simulation output data 20 in the storage unit 11.

Subsequently, the classifying unit 12 classifies a plurality of data items included in the simulation output data 20 based on the difference between the model elements according to the item-model correspondence information 21 (S2) and stores the classification result 23 in the storage unit 11. Subsequently, the converting unit 13 integrates the data items included in the groups of the data items classified based on the difference between the model elements in the classification result 23 based on the integration rule information 22 (S3). Subsequently, the converting unit 13 stores the conversion result 24 obtained as the results of integration of the simulation output data in the storage unit 11.

Subsequently, the identifying unit 14 identifies a combination of data items having an appearance tendency equal to or higher than a predetermined value in the simulation output data 20 resulting from conversion based on the conversion result 24 (S4). Subsequently, the output unit 15 outputs the combination relating to the data items identified by the identifying unit 14 to a display or a file (S5), and the processing is ended.

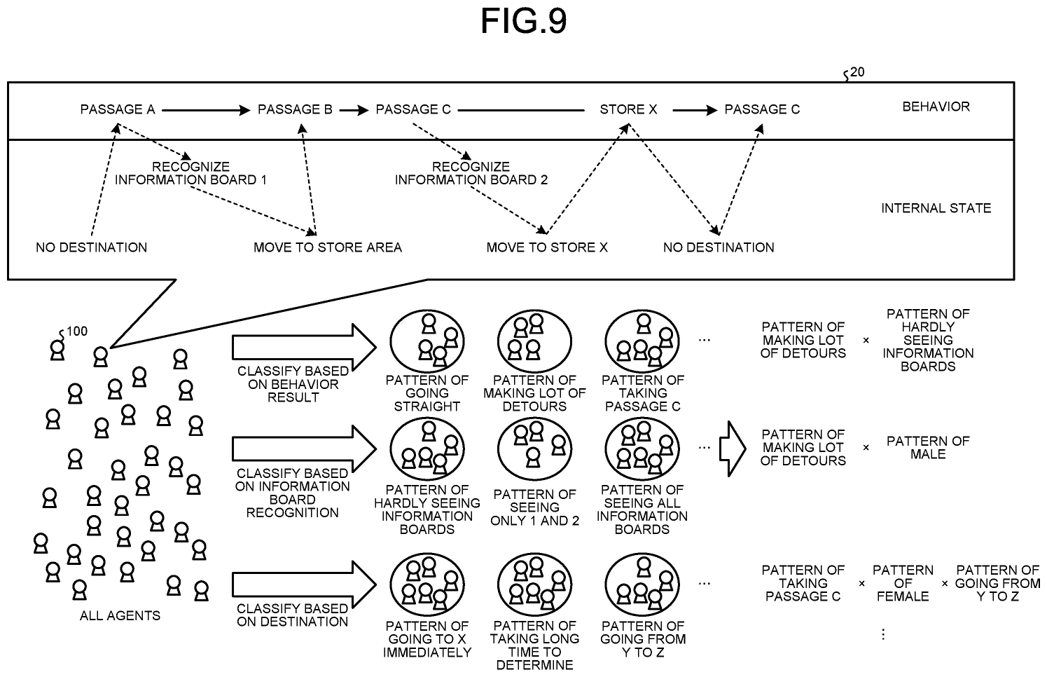

FIG. 9 is a diagram for explaining identification of combinations. As illustrated in FIG. 9, the analyzing apparatus 1 classifies the data items in the simulation output data 20 including the logs of the agents 100 based on the difference between the model elements and organizes the data in each of the groups resulting from classification. The analyzing apparatus 1, for example, organizes the data items relating to “behavior result” in the behavior model 103 into clusters, such as a pattern of going straight, a pattern of making a lot of detours, and a pattern of taking a passage C. The analyzing apparatus 1 organizes the data items relating to “information board recognition” in the recognition model 102 into clusters, such as a pattern of hardly seeing the information boards, a pattern of seeing only 1 and 2, and a pattern of seeing all the information boards. The analyzing apparatus 1 organizes the data items relating to “destination” in the attribute model 101 into clusters, such as a pattern of going to X immediately, a pattern of taking a long time to determine, and a pattern of going from Y to Z.

As described above, the analyzing apparatus 1 reduces the number of types of data, thereby facilitating finding out the combination of data items having an appearance tendency equal to or higher than a predetermined value with respect to the congestion agent group and correlating with each other.

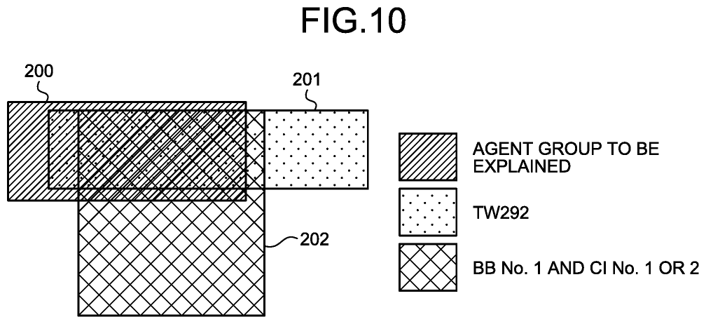

FIG. 10 is a diagram for explaining consideration of a measure from the identified combination. As illustrated in FIG. 10, let us assume a case where a set 201 and a set 202 of the agent groups are present corresponding to a set 200 of the agent groups to be explained. The set 201 is composed of the agent groups having an object of Flight TW292, and a set 202 is composed of the agent groups that use BB No. 1 and CI No. 1 or 2. In this case, the analyzing apparatus 1 identifies a combination of the data items of the attribute (having an object of TW292) and the behavior (using BB No. 1 and CI No. 1 or 2) based on the overlapping parts of the set 201 and the set 201 on the set 200. As a result, it is found that a measure to avoid using BB No. 1 and CI No. 1 or 2 is effective for the passengers of TW292, for example.

Effects

As described above, the analyzing apparatus 1 includes the classifying unit 12, the converting unit 13, and the identifying unit 14. The classifying unit 12 classifies a plurality of data items included in the simulation output data 20 output by carrying out a simulation using a plurality of agents 100 into a plurality of groups based on the difference between model elements (the attribute model 101, the recognition model 102, and the behavior model 103) of the data output sources of the respective data items in the agents 100. The converting unit 13 converts the data items included in a group having a plurality of data items out of the groups into a smaller number of data items than the number of data items included in the group based on the integration rule information 22 that describes predetermined rules. The identifying unit 14 identifies a combination of data items having an appearance tendency equal to or higher than a predetermined value in the output data resulting from the conversion using a known machine learning technique, for example.

As described above, the analyzing apparatus 1 reduces the number of data items by dividing them into groups based on the difference between the model elements of the data output sources. As a result, the analyzing apparatus 1 can prevent the number of data items to be considered for congestion or the like from increasing. Consequently, the analyzing apparatus 1 can support a data analysis so as to facilitate consideration of a measure. The analyzing apparatus 1 can readily identify a combination of data items having an appearance tendency equal to or higher than the predetermined value due to congestion and other factors and can proceed the consideration of a measure to eliminate the congestion at an early stage.

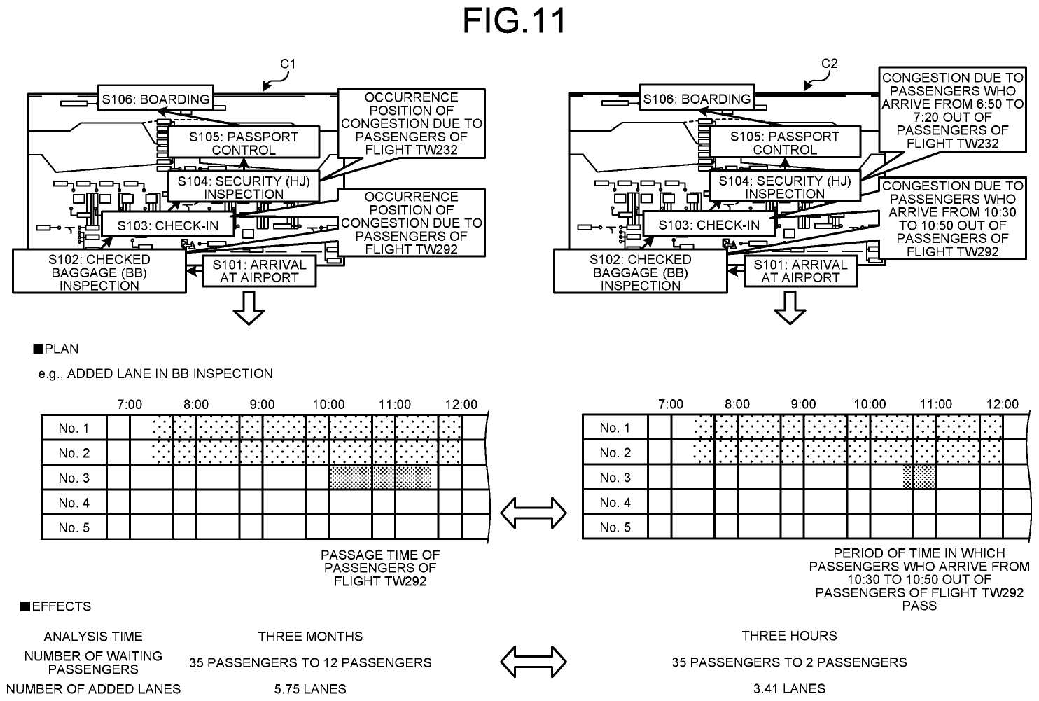

FIG. 11 is a diagram for explaining an example of the effects. In FIG. 11, the analyzing apparatus 1 analyzes the simulation output data 20 in the process of arrival at the airport (S101), checked baggage (BB) inspection (S102), check-in (S103), security (HJ) inspection (3104), passport control (S105), and boarding (S106).

In a case C1, an expert analyzes the data items in the simulation output data 20 without any change. In a case C2, the analyzing apparatus 1 organizes the data items based on the difference between the model elements.

As illustrated in FIG. 9, the case C1 has an enormous number of types (number of items) of data to be considered. As a result, the expert can determine that congestion of the passengers of Flight TW292 occurs at S102 and S103 and that congestion of the passengers of Flight TW232 occurs at S104 at best.

In the case C2, the analyzing apparatus 1 prevents the number of data items to be considered for congestion or the like from increasing. As a result, the analyzing apparatus 1 can readily identify a combination of data items having an appearance tendency equal to or higher than the predetermined value due to congestion and other factors. The user, for example, can readily find out that congestion occurs due to passengers who arrive from 10:30 to 10:50 out of the passengers of Flight TW292 at S102 and S103. Furthermore, the user can readily find out that congestion occurs due to passengers who arrive from 6:50 to 7:20 out of the passengers of Flight TW232 at S104.

Consequently, the analysis time can be reduced in the case C2 compared with in the case C1. Furthermore, the user can create a measure in the case C2 superior to that in the case C1 in the reduction ratio of the number of waiting passengers and the number of added lanes (capital investment) based on the identified combinations of data items.

By applying the log data on the agent 100 having behavior satisfying a predetermined condition, such as a waiting time in a line of 30 minutes or longer, in the simulation output data 20, the user can consider a measure corresponding to the condition, such as congestion.

The converting unit 13 converts the data items included in each group resulting from classification based on the rules corresponding to the model elements of the group according to the integration rule information 22 that describes the rules corresponding to the model elements of the group. Consequently, the analyzing apparatus 1 can convert the data items corresponding to the attribute model 101, the recognition model 102, the behavior model 103, or the sub-models of the models (the position information recognition model 102a, the congestion information recognition model 102b, . . . ).

The converting unit 13 converts a plurality of data items included in a group into one data item. The analyzing apparatus 1, for example, may organize a plurality of data items relating to the information board recognition model serving as a sub-model of the recognition model 102 into one data item. As a result, the analyzing apparatus 1 can deal with recognition of an information board by the agent 100 as one data item. Consequently, the analyzing apparatus 1 can support a data analysis so as to facilitate the user's considering a measure.

The converting unit 13 converts the data items resulting from conversion into values corresponding to the clusters obtained by clustering. As a result, the analyzing apparatus 1 can evaluate the data items not as fine values but as roughly divided values as the clusters, thereby facilitating a data analysis. The analyzing apparatus 1, for example, can facilitate evaluation of the length of the waiting time of the agent 100 by the clusters divided by a predetermined threshold and the clusters divided based on the distribution of the waiting time.

As the number of simulations increases to conduct inspection on various conditions, for example, the number of pieces of output result data increases. It is troublesome to manually identify the data items and the combinations of the data items relating to the causes of congestion from a number of pieces of result data. To address this, a machine learning technique may possibly be used like the present embodiment. If a machine learning technique is used, however, data items having a high matching ratio with the congestion agent group and combinations of their values are mechanically output. The output results include combinations of data items not leading to any measure and data items and combinations making it difficult to implement the measure based on the identified result. The analyzing apparatus 1 according to the present embodiment, for example, includes the output unit 15 that outputs the combinations of the data items identified by the identifying unit 14. Consequently, the user can check the combinations of the data items output by the output unit 15 to consider a measure.

The data items resulting from conversion are each any one of the data item relating to an effect (behavior) of the agent 100 to the environment 105 in the simulation, the data item relating to acquisition of information (recognition) by the agent 100 from the environment 105, and the data item relating to predefinition (attributes) on the agent 100. The output unit 15 outputs a combination including the data item relating to the effect of the agent 100 and including at least one of the data item relating to the effect and the data item relating to the acquisition of information.

The models (agent models) for simulating the behavior relating to the agent 100 includes the attribute model 101, the recognition model 102, and the behavior model 103 as the elements of the agent 100. The data items relating to the behavior of the agent 100 in the behavior model 103 out of the elements affect the environment 105 surrounding the agent 100 and have an effect on subsequent behavior or recognition of the agent 100. By considering the combinations of the data items relating to the behavior of the agent 100 with other items, the user can readily presume the cause-and-effect relation of an event (e.g., congestion) occurring due to the behavior of the agent 100.

The analyzing apparatus 1 outputs the combinations of the data items relating to the behavior of the agent 100 with other items in the combinations of the data items having an appearance tendency equal to or higher than a predetermined value, that is, the combinations having the relation of attribute-recognition-behavior in the agent 100. Consequently, the analyzing apparatus 1 can support the consideration of a measure to eliminate congestion, for example.

Others

All or desired part of various processing functions in the analyzing apparatus 1 may be performed on a CPU (or a microcomputer, such as an MPU and a micro controller unit (MCU)). Naturally, all or desired part of the various processing functions may be performed on a computer program analyzed and executed by the CPU (or a microcomputer, such as an MPU and an MCU) or on hardware by wired logic. Furthermore, the various processing functions in the analyzing apparatus 1 may be performed by a plurality of computers cooperating by cloud computing.

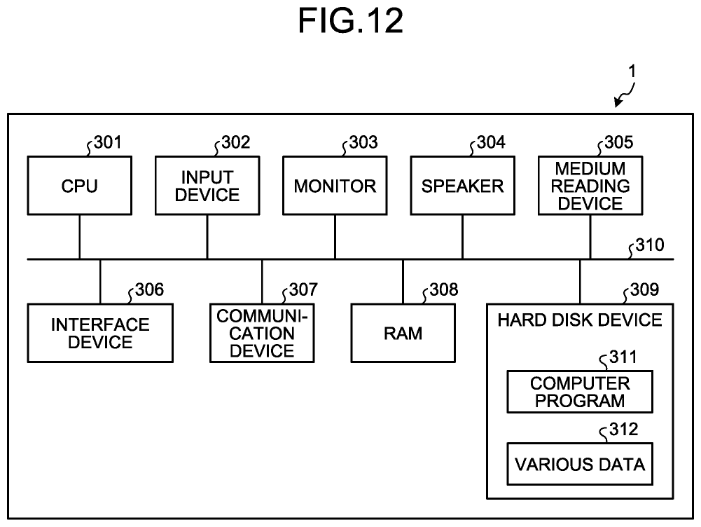

The various kinds of processing described in the embodiment above can be performed by a computer executing a computer program prepared in advance. The following describes an example of a computer (hardware) that executes a computer program having the same functions as those of the embodiment above. FIG. 12 is a block diagram of an example of a hardware configuration of the analyzing apparatus 1 according to the embodiment.

As illustrated in FIG. 12, the analyzing apparatus 1 includes a CPU 301, an input device 302, a monitor 303, and a speaker 304. The CPU 301 performs various kinds of arithmetic processing. The input device 302 receives input of data. The analyzing apparatus 1 also includes a medium reading device 305, an interface device 306, and a communication device 307. The medium reading device 305 reads a computer program and the like from a storage medium. The interface device 306 connects the analyzing apparatus 1 to various devices. The communication device 307 connects the analyzing apparatus 1 to external devices by wired or wireless communications. The analyzing apparatus 1 also includes a RAM 308 and a hard disk device 309. The RAM 308 temporarily stores therein various kinds of information. The components (301 to 309) in the analyzing apparatus 1 are connected to a bus 310.

The hard disk device 309 stores therein a computer program 311 for performing various kinds of processing of the input unit 10, the storage unit 11, the classifying unit 12, the converting unit 13, the identifying unit 14, and the output unit 15 described in the embodiment above. The hard disk device 309 also stores therein various data 312, such as the simulation output data 20, the item-model correspondence information 21, and the integration rule information 22, referred to in execution of the computer program 311. The input device 302 receives input of operating information from an operator of the analyzing apparatus 1, for example. The monitor 303 displays various screens operated by the operator, for example. The interface device 306 is connected to a printer, for example. The communication device 307 is connected to a communication network, such as a local area network (LAN), and transmits and receives various kinds of information to and from the external devices via the communication network.

The CPU 301 reads the computer program 311 stored in the hard disk device 309 and loads and executes it on the RAM 308, thereby performing various kinds of processing of the input unit 10, the storage unit 11, the classifying unit 12, the converting unit 13, the identifying unit 14, and the output unit 15. The computer program 311 is not necessarily stored in the hard disk device 309. The computer program 311 may be stored in a storage medium readable by the analyzing apparatus 1, for example, and be read and executed by the analyzing apparatus 1. Examples of the storage medium readable by the analyzing apparatus 1 include, but are not limited to, a portable recording medium such as a CD-ROM, a DVD disk, and a universal serial bus (USB) memory, a semiconductor memory such as a flash memory, a hard disk drive, etc. Furthermore, the computer program 311 may be stored in a device connected to a public network, the Internet, or a LAN, for example, and be read and executed by the analyzing apparatus 1.

One aspect can support an analysis of a people flow simulation using a plurality of agents.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
classifying a plurality of data items included in outputted data output by carrying out a simulation using a plurality of agents into a plurality of groups based on difference between model elements of data output sources of the respective data items in the agents;
converting the data items included in a group having a plurality of data items out of the groups into a smaller number of data items than a number of data items included in the group based on a predetermined rule; and
identifying a combination of the data items having an appearance tendency equal to or higher than a predetermined value in the outputted data resulting from the converting.

2. The non-transitory computer-readable recording medium according to claim 1, wherein the outputted data is log data on the agents having behavior in the simulation satisfying a predetermined condition.

3. The non-transitory computer-readable recording medium according to claim 1, wherein the converting includes converting the data items included in the group resulting from the classifying based on a rule corresponding to the model elements of the group.

4. The non-transitory computer-readable recording medium according to claim 1, wherein the converting includes converting the data items included in the group into one data item.

5. The non-transitory computer-readable recording medium according to claim 1, wherein the converting includes converting the data items resulting from conversion into a value corresponding to a cluster obtained by clustering.

6. The non-transitory computer-readable recording medium according to claim 1, further causing the computer to execute outputting the identified combination of the data items.

7. The non-transitory computer-readable recording medium according to claim 6, wherein
the data items resulting from conversion are each any one of a data item relating to an effect of the agents to an environment in the simulation, a data item relating to acquisition of information by the agents from the environment, and a data item relating to predefinition on the agents, and
the outputting includes outputting the combination including the data item relating to the effect and including at least one of the data item relating to the effect and the data item relating to the acquisition of information.

8. An analysis method comprising:
classifying a plurality of data items included in outputted data output by carrying out a simulation using a plurality of agents into a plurality of groups based on difference between model elements of data output sources of the respective data items in the agents, by a processor;
converting the data items included in a group having a plurality of data items out of the groups into a smaller number of data items than a number of data items included in the group based on a predetermined rule, by the processor; and
identifying a combination of the data items having an appearance tendency equal to or higher than a predetermined value in the outputted data resulting from the converting, by the processor.

9. The analysis method according to claim 8, wherein the outputted data is log data on the agents having behavior in the simulation satisfying a predetermined condition.

10. The analysis method according to claim 8, wherein the converting includes converting the data items included in the group resulting from the classifying based on a rule corresponding to the model elements of the group.

11. The analysis method according to claim 8, wherein the converting includes converting the data items included in the group into one data item.

12. The analysis method according to claim 8, wherein the converting includes converting the data items resulting from conversion into a value corresponding to a cluster obtained by clustering.

13. The analysis method according to claim 8, further comprising outputting the identified combination of the data items, by the processor.

14. The analysis method according to claim 13, wherein
the data items resulting from conversion are each any one of a data item relating to an effect of the agents to an environment in the simulation, a data item relating to acquisition of information by the agents from the environment, and a data item relating to predefinition on the agents, and
the outputting includes outputting the combination including the data item relating to the effect and including at least one of the data item relating to the effect and the data item relating to the acquisition of information.

15. An analyzing apparatus comprising a processor that executes a process comprising:
classifying a plurality of data items included in outputted data output by carrying out a simulation using a plurality of agents into a plurality of groups based on difference between model elements of data output sources of the respective data items in the agents;
converting the data items included in a group having a plurality of data items out of the groups into a smaller number of data items than a number of data items included in the group based on a predetermined rule; and
identifying a combination of the data items having an appearance tendency equal to or higher than a predetermined value in the outputted data resulting from the converting.
